(19) United States
(12) Patent Application Publication
(10) Pub. No.: US 2006/0055134 A1
(43) Pub. Date: Mar. 16, 2006

(54) Hand cart

(76) Inventors: John E. McLoughlin, Lake Grove, NY (US); Neocles G. Athanasiades, Setauket, NY (US); Toh M. Meng, Hauppauge, NY (US)

Correspondence Address: Frank L. Hart, 8911 S. 73rd East Ave., Tulsa, OK, 74133, US

(21) Appl. No.: 10/942,283

(22) Filed: Sep. 16, 2004

(51) Int. Cl. B62B 1/00

(52) U.S. Cl. 280/47.28

(57) ABSTRACT

An improved hand cart has an elevator and a power system for controllably moving the elevator between an at rest position adjacent the ground and an elevated position. The hand cart has a pair of wheels for moving the hand cart and any accompanying load along the ground.

### BACKGROUND OF THE INVENTION

1. Field of the Invention

The subject invention relates to hand carts for mechanically transporting articles. More particularly, the subject invention relates to an improved hand cart which is adapted to also elevate articles for purposes of loading articles onto or off of the handcart.

2. Description of Related Art Including Information Disclosed Under 37 CFR 1.97 and 1.98

The hand cart or hand truck of this invention is similar to heretofore utilized hand trucks which were incorporated to move articles laterally across the ground. However, it was discovered that the hand carts were extensively used with items that weighed considerably more than an individual worker could conveniently and safely lift to a resting place that was higher in elevation. An example of such use of a hand cart is the transporting of an oxygen bottle, which sometimes weighs in excess of one hundred pounds, and then lifting the oxygen bottle from immediately adjacent ground elevation into the bed of a truck or ambulance.

Accidents often happened during movement of the oxygen bottle to a higher elevation. Sometimes the operator would smash his fingers. Other times the oxygen bottle would be accidentally dropped which often resulted into injury to the operator, an adjacent item which was struck by the falling bottle, or damage to the bottle itself. Other accidents during lifting of the excessively heavy bottles involved permanent injury to the operators lower back.

Another example of such heavy weight objects that are customarily transported by hand carts and then necessarily loaded into the bed of a truck are heavy weight acetylene bottles that are used in welding.

The present invention is directed to overcome one or more of the problems as set forth above.

### BRIEF SUMMARY OF THE INVENTION

In one aspect of the invention, a hand cart which has an “L” shaped frame connected to a pair of wheels and including a base and an upright member extending upwardly from the base, is improved by connecting an elevator to the hand cart frame. The elevator has a base and an upright element extending upwardly from the base. The elevator is slidably connected to the hand cart and a lifting system is connected to the elevator and the hand cart frame and adapted to controllably move the elevator to preselected elevations.

### BRIEF DESCRIPTION OF THE SEVERAL VIEWS OF THE DRAWING(S)

FIG. 1 is a side view of the improved hand cart of this invention;

FIG. 2 is a sectional view taken along line II-II of FIG. 1 with portions of the cart removed;

FIG. 3 is a diagrammatic view of one lifting system of this invention;

FIG. 4 is a diagrammatic side view of the improved hand cart of this invention which has a hydraulically actuated lifting system; and

FIG. 5 is a rear view of a portion of the improved hand cart of this invention showing the position of the wheels on the hand cart.

### DETAILED DESCRIPTION OF THE INVENTION

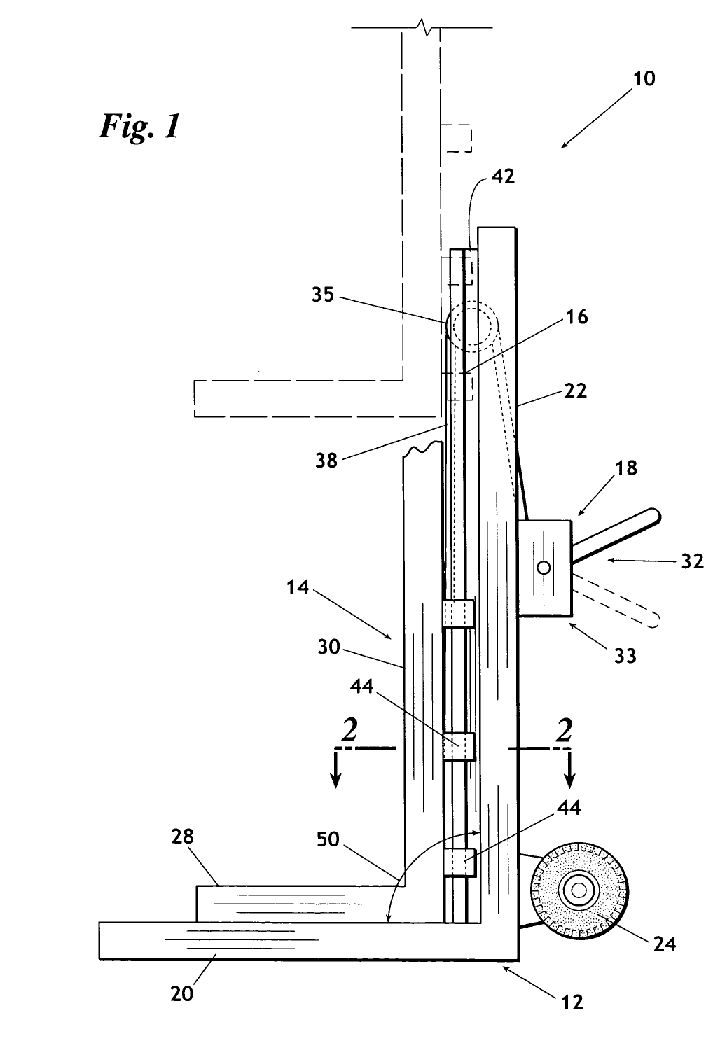

Referring to FIG. 1, the improved hand truck or cart 10 of this invention has a frame 12, and elevator 14, means 16 for slidably connecting the elevator 14 to the cart frame 12 and a lifting system 18 connected to the cart frame 12 and the elevator 14. The cart frame 12 has a cart base 20, a cart upright 22, and a pair of wheels 24, 26 connected to the upwardly extending cart upright 22 at a location at which the wheels 24,26 are spaced from the ground in the upright position of the cart 10. The elevator 14 has a base 28 and an upright element 30 connected to and extending upwardly from the base 28.

A lifting system 32 is connected to the elevator 14 and the cart frame 12 and is adapted to controllably move the elevator 14 between an at rest position, shown by solid lines, at which the cart base 20 and the elevator base 28 are in contact one with the other and an elevated position, shown by broken lines, at which the elevator base 28 is at a higher elevation than the cart base 20.

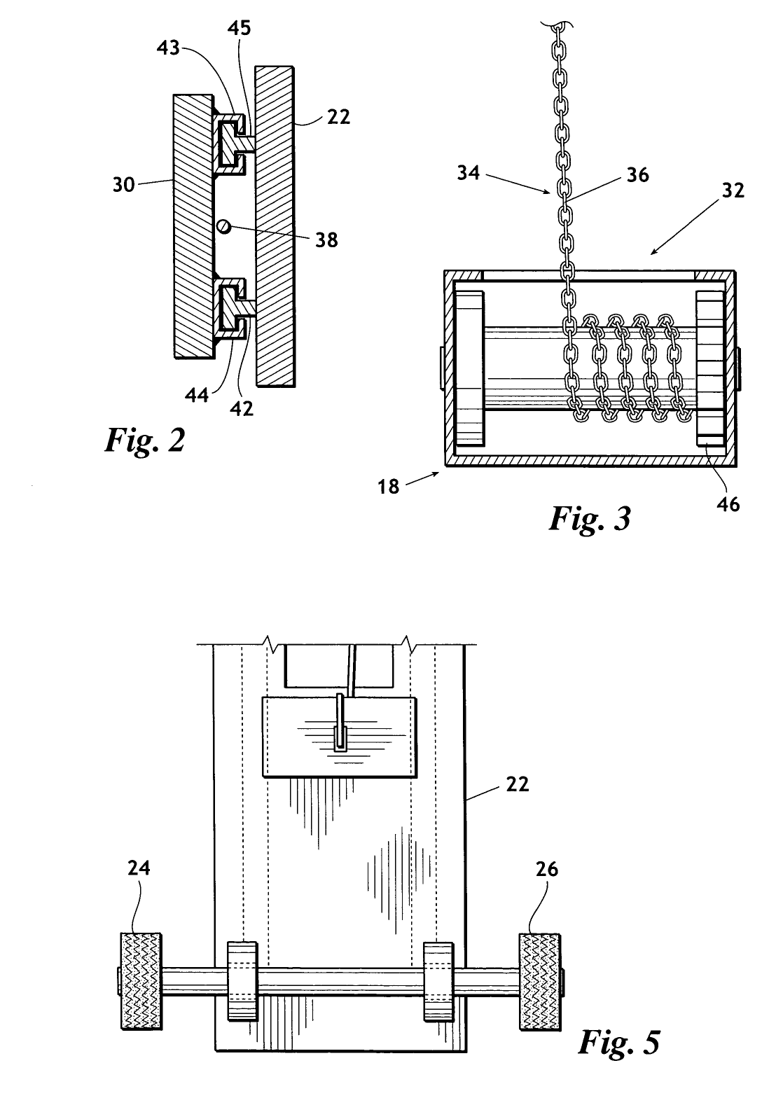

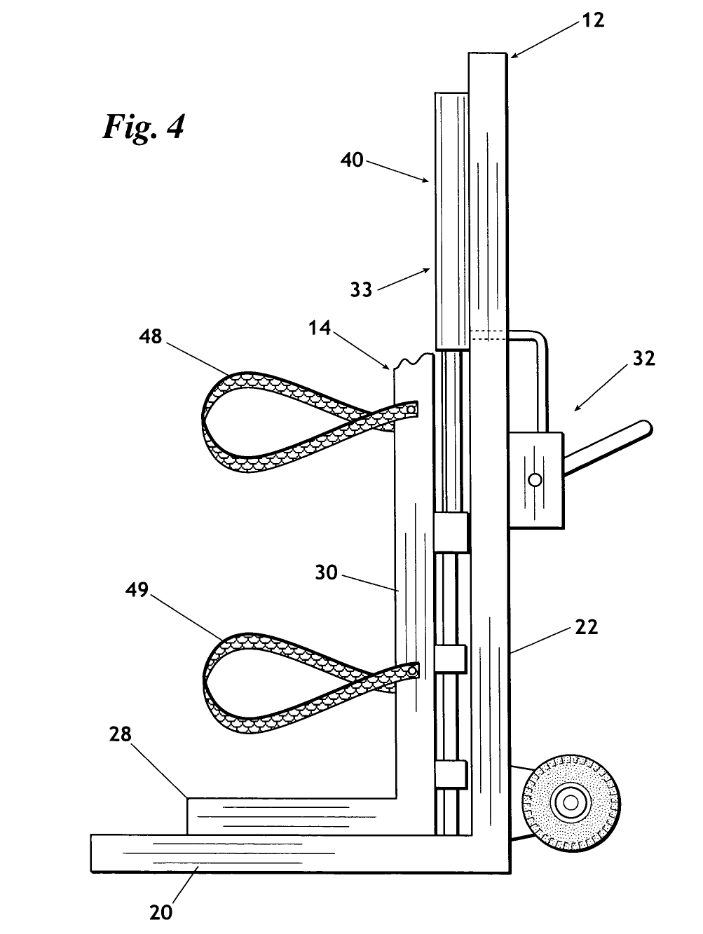

The lifting system 32 of FIG. 1 has a flexible member 34, such as a chain 36 as shown in FIG. 3 or a rope or cable 38 as better seen in FIGS. 1 and 2. One end of the flexible member 34 is connected to the elevator 14, the flexible member 34 passes over a pulley 35 which is attached to the cart upright 22 and the other end is connected to a power means 33 of the lifting system 32 which is connected to the cart upright 22. Another embodiment of the lifting system 32 is shown in FIG. 4 wherein the power means 33 for moving the elevator 14 is a fluid cylinder 40 which has a first end connected to the cart frame 12 and a second end connected to the elevator 14. The fluid of the fluid cylinder can be air or a liquid such as hydraulic oil.

The cart frame upright 22 has one of a guide rail 42 and a rail retainer 44 connected thereto and the elevator upright element 30 has the other of said guide rail 42 and rail retainer 44 connected thereto. In the preferred embodiment shown in FIGS. 1 and 2, there are two spaced apart guide rails 42, 43. These guide rails 42, 43 are of a general “T” cross sectional configuration. The rail retainers 44, 45 extend about a portion of the associated guide rails 42, 43. The rails 42, 43 and rail retainers 44,45 can be connected to their respective cart frame 12 or elevator upright element 30 by various means known in the art such as, for example, by welding.

In the preferred embodiment of the lifting system 18 as shown in FIG. 3, a geared ratchet 46 is utilized which is adapted to require mechanical motion by an operator to move the elevator 14 a preselected distance upwardly and a preselected distance downwardly. Such a lifting system 18 is well known in the art and often utilized in a mechanical car jack thereby preventing the object being moved from moving at an unsafe speed or falling.

In the preferred embodiment of this invention, the lifting system 18 is adapted for moving the elevator 14, via a battery operated electric motor, a vertical distance in the range of about zero inches to about six feet. Many of the locations at which oxygen bottles or other objects are required to be positioned are four or more feet above ground level. More preferably the lifting system 18 is adapted for moving the elevator 14 a vertical distance greater than about four feet which is sufficiently high to reach the bed of most trucks.

Although FIG. 2 shows the preferred embodiment of a pair of guide rails 42,43 and associated rail retainers 44,45, it should be understood that the connecting means 16 can be only the flexible member 34 or can be of other construction. Examples of such other construction are outwardly extending stops positioned on opposed sides of the cart upright 22 in the pathway of the elevator upright element 30 maintaining against movement of the element sideways across the cart upright 22. In another construction, grooves can be formed in either the cart upright 22 or the elevator upright element 30, which grooves receive protrusions extending from the other of the uprights 22 or 30. It should also be understood that connecting and maintaining means of other construction can be utilized without departing from this invention. Since it is often required to raise the heavy loads to a relatively high elevations, it is important that the cart 10 be stable at the elevated position of the elevator 14. To provide such desired stability, one or more retaining straps 48, 49, see FIG. 4, are connected to the elevator upright element 30 and adapted to encircle and maintain an object on the elevator 14. Further, as shown in FIGS. 1 and 5, the wheels 24, 26 are connected to the elevator upright element 30 at a location sufficient for said wheels 24, 26 being at a higher elevation than the cart base 20 when the cart upright element 30 is in a general vertical position, as shown in FIG. 1 and that each wheel 24, 26 be positioned on an opposed side of the cart base 20 at a location outwardly spaced from a respective side of the base 20 a distance of at least six inches. For further increasing stability it is preferred that the length of the cart base 20 is greater than the length of the elevator base 28 and that the cart upright 22 be oriented relative to the cart base 20 at an angle 50 less than ninety degrees.

Other aspects, objects, and advantages can be obtained from a study of the drawings, the disclosure and the appended claims.

1. In an improved hand cart having an “L” shaped frame connected to a pair of wheels, said frame having a base and an upright member extending upwardly from the base, the improvement comprising:
an elevator having a base and an upright element extending upwardly from the base;
means for slidably connecting the elevator to the hand cart; and
a lifting system connected to the elevator and the hand cart frame and being adapted to controllably move the elevator between an at rest position at which the cart base and the elevator base are in contact one with the other and an elevated position at which the elevator base is at a higher elevation than the cart base.

2. An improved hand cart, as set forth in claim 1, wherein the lifting system includes a flexible having a first end connected to the elevator and a second end connected to a mechanical drive mechanism connected to the hand cart frame, said flexible member having a middle portion passing over a pulley connected to the hand cart frame at a location higher in elevation than the first end of the flexible member.

3. An improved hand cart, as set forth in claim 2, wherein the flexible member is a chain.

4. An improved hand cart, as set forth in claim 2, wherein the flexible member is a cable.

5. An improved hand cart, as set forth in claim 1 wherein the lifting system includes a fluid cylinder which has first and second ends, said first end being connected to the cart frame and the second end connected to the elevator.

6. An improved hand cart, as set forth in claim 1, wherein the wheels are connected to the frame upright element at a location sufficient for said wheels being at a higher elevation than the frame base when the frame upright element is in a vertical position.

7. An improved hand cart, as set forth in claim 1, wherein the frame upright has one of a guide rail and rail retainer connected thereto and the elevator upright element has the other of the guide rail and rail retainer connected thereto, said rail retainer extending about a portion of the guide rail and adapted to slidably maintain the elevator with the cart frame.

8. An improved hand cart, as set forth in claim 7, wherein the guide rail is of a general “T” crossectional configuration.

9. An improved hand cart, as set forth in claim 1, wherein the lifting system includes a ratchet which requires mechanical motion by an operator to move the elevator a preselected distance upwardly and a preselected distance downwardly.

10. An improved hand cart, as set forth in claim 1, wherein the frame upright extends from the frame base at an angle less than ninety degrees.

11. An improved hand cart, as set forth in claim 1, wherein the wheels are each positioned on an opposed side of the frame base at a location outwardly spaced from a respective side of the base a distance of at least six inches.

12. An improved hand cart, as set forth in claim 1 wherein the elevator upright includes first and second safety straps each of a length sufficient for encircling and maintaining an object on the elevator.

13. An improved hand cart, as set forth in claim 1, wherein the lifting system is adapted for moving the elevator a vertical distance in the range of about six inches to about six feet.

14. An improved hand cart, as set forth in claim 13, wherein the lifting system is adapted for moving the elevator a vertical distance of at least four feet.

15. An improved hand cart, as set forth in claim 1, wherein the lifting system is adapted for moving the elevator a vertical distance in the range of about 6 inches to about six feet via a battery operated electric motor.
